(19) United States
(12) Patent Application Publication
(10) Pub. No.: US 2010/0294603 A1
(43) Pub. Date: Nov. 25, 2010

(54) BRAKE WITH FIELD RESPONSIVE MATERIAL

(76) Inventors: Kenneth A. St. Clair, Cary, NC (US); Robert H. Marjoram, Holly Springs, NC (US); William C. Hardin, Cary, NC (US); Marlene E. Hontz, Moncure, NC (US); Stephen P. Koester, Portland, OR (US)

Correspondence Address: LORD CORPORATION;PATENT & LEGAL SERVICES, 111 LORD DRIVE, P.O. Box 8012, CARY, NC, 27512-8012, US

(21) Appl. No.: 12/520,782

(22) PCT Filed: Dec. 21, 2007
(86) PCT No.: PCT/US07/88574

§ 371 Date: Jun. 25, 2010

Related U.S. Application Data
(60) Provisional application No. 60/871,610, filed on Dec. 22, 2006.

(51) Int. Cl. F16F 15/03

(52) U.S. Cl. 188/267

(57) ABSTRACT

A controllable brake with a shaft having an axis of rotation and a shaft end. The controllable brake including a controllable brake rotor connected with the shaft, the rotor having a rotation plane. The controllable brake includes a controllable brake magnetic field generator located proximate the controllable brake rotor, the controllable brake magnetic field generator for generating a controllable magnetic field strength. The controllable brake includes a controllable brake rotating magnetic target integral with the shaft proximate the shaft end, and a controllable brake electronics first electronic noncontacting magnetic sensor having a first sensor plane, the first electronic noncontacting magnetic sensor mounted with the first sensor plane parallel with the controllable brake rotor rotation plane, the first electronic noncontacting magnetic sensor monitoring the rotation of the controllable brake rotating magnetic target and the controllable brake rotor and simultaneously outputting at least two rotational positions of the controllable brake rotor wherein the controllable magnetic field strength generated by the controllable brake magnetic field generator is determined by the rotational positions to control a relative motion of the controllable brake rotor.

### CROSS REFERENCE TO RELATED APPLICATIONS

The present application claims priority to U.S. Provisional Patent Application Ser. No. 60/871,610, filed Dec. 22, 2006, which is incorporated herein by reference.

### FIELD OF THE INVENTION

The invention relates to the field of motion control devices. The invention relates to the field of controllable brakes and methods of controlling motion. More particularly the invention relates to the field of controllable brakes with magnetic field responsive materials.

### BACKGROUND OF THE INVENTION

There is a need for controllable brakes for controlling motion. There is a need for controllable brakes and a method of accurately and economically controlling motion. There is a need for an economically feasible method of controlling motion accurately with a brake utilizing magnetic fields. There is a need for a robust controllable brake and method of making controllable brakes with improved performance. There is a need for an economic controllable brake and method of controlling motion with a magnetic field responsive material and a magnetic field generator.

### SUMMARY OF THE INVENTION

In an embodiment the invention includes a controllable brake. The controllable brake preferably includes a housing including a first chamber and a second chamber. The controllable brake preferably includes a shaft, the shaft extending through the first chamber and the second chamber with an axis of rotation, the shaft having a first shaft end. The controllable brake preferably includes a controllable brake rotor made integral with the shaft, the rotor housed in the first chamber. The controllable brake preferably includes a controllable brake magnetic field generator located in the first chamber proximate the controllable brake rotor, the controllable brake magnetic field generator for generating a controllable magnetic field strength. The controllable brake preferably includes a controllable brake rotating magnetic target integrated with the shaft proximate the first shaft end, the controllable brake rotating magnetic target housed in the second chamber. The controllable brake preferably includes a controllable brake electronics circuit board mounted in the second chamber, the controllable brake electronics circuit board having a control board plane, the control board plane oriented normal to the shaft axis of rotation. The controllable brake preferably includes a first electronic noncontacting magnetic sensor having a first sensor plane, the first electronic noncontacting magnetic sensor integrated on the controllable brake electronics circuit board with the first sensor plane parallel with the control board plane. The controllable brake preferably includes a second electronic noncontacting magnetic sensor having a second sensor plane, the second electronic noncontacting magnetic sensor integrated on the controllable brake electronics circuit board with the second sensor plane parallel with the control board plane with the control board plane between the first sensor plane and the second sensor plane, the first electronic noncontacting magnetic sensor and the second electronic noncontacting magnetic sensor monitoring the rotation of the controllable brake rotating magnetic target and outputting a rotational position of the controllable brake rotating magnetic target wherein the controllable magnetic field strength generated by the controllable brake magnetic field generator is determined by the rotational position to control a relative motion of the controllable brake rotor.

In an embodiment the invention includes a controllable brake. The controllable brake preferably includes a rotating magnetic target. The controllable brake preferably includes a magnetically permeable rotor. The controllable brake preferably includes a shaft connected to the magnetically permeable rotor. The controllable brake preferably includes a housing having a first housing chamber rotatably housing the magnetically permeable rotor therein, and including a magnetic field generator spaced from the magnetically permeable rotor, and configured and positioned for generating a controllable magnetic field to control a relative motion of the magnetically permeable rotor, and a second housing chamber containing control electronics therein, the second housing chamber electronics including at least a first oriented electronic noncontacting magnetic sensor, the at least first oriented electronic noncontacting magnetic sensor oriented relative to the rotating magnetic target and the shaft wherein the at least first oriented electronic noncontacting magnetic sensor monitors the rotation of the rotating magnetic target.

In an embodiment the invention includes a method of controlling motion. The method preferably includes providing a housing having a first housing chamber and a second housing chamber. The method preferably includes providing a shaft with a magnetically permeable rotor, the shaft including a rotating magnetic target distal from the magnetically permeable rotor. The method preferably includes providing a magnetic field generator for generating a magnetic field with a controllable field strength for controlling a relative motion of the magnetically permeable rotor. The method preferably includes providing at least a first electronic noncontacting magnetic sensor, the at least first electronic noncontacting magnetic sensor integrated on an operation electronic control board having a control board plane. The method preferably includes disposing the magnetically permeable rotor and the magnetic field generator in the first housing chamber. The method preferably includes disposing the rotating magnetic target and the at least a first electronic noncontacting magnetic sensor in the second housing chamber, wherein the operation electronic control board is in electrical communication with the magnetic field generator and the control board plane is oriented relative to the rotating magnetic target, wherein the at least first electronic noncontacting magnetic sensor provides a detected measured rotational position of the rotating magnetic target with the controllable field strength generated in relationship to the detected measured rotational position sensed by the at least first electronic noncontacting magnetic sensor.

In an embodiment the invention includes a method of making a motion control brake for controlling motion. The method preferably includes providing a magnetic field generator for generating a magnetic field with a controllable field strength for controlling a relative motion of a movable brake member. The method preferably includes providing a magnetic target which moves with the relative motion of the movable brake member. The method preferably includes providing an electronic circuit board having a circuit board plane, a first oriented electronic noncontacting magnetic sensor having a first oriented sensor plane, the first electronic noncontacting magnetic sensor integrated on the electronic circuit board with the first sensor plane parallel with the circuit board plane, a second oriented electronic noncontacting magnetic sensor having a second oriented sensor plane, the second electronic noncontacting magnetic sensor integrated on the electronic circuit board with the second sensor plane parallel with the circuit board plane with the circuit board plane between the second sensor plane and the first sensor plane. The method preferably includes disposing the electronic circuit board proximate the magnetic target wherein the first electronic noncontacting magnetic sensor and the second electronic noncontacting magnetic sensor provide a detected measured magnetic target position with the controllable field strength generated by the magnetic field generator determined by the detected measured magnetic target position.

In an embodiment the invention includes a method of making a control system. The method preferably includes providing a control system rotating magnetic target having an axis of rotation. The method preferably includes providing a control system electronic circuit board having a circuit board plane and a first circuit board side and an opposite second circuit board side, a first oriented electronic noncontacting magnetic sensor integrated on the electronic circuit board first circuit board side, a second oriented electronic noncontacting magnetic sensor integrated on the electronic circuit board second circuit board side. The method preferably includes disposing the control system electronic circuit board proximate the control system rotating magnetic target with a projected extension of the axis of rotation extending through the first oriented electronic noncontacting magnetic sensor and the second oriented electronic noncontacting magnetic sensor wherein the first electronic noncontacting magnetic sensor and the second electronic noncontacting magnetic sensor provide a plurality of detected measured magnetic target rotary position outputs.

In an embodiment the invention includes a method of controlling motion. The method preferably includes providing a magnetic field generator for generating a magnetic field with a controllable field strength. The method preferably includes providing a field responsive controllable material, the field responsive controllable material affected by the magnetic field generator magnetic field. The method preferably includes providing a magnetic target. The method preferably includes providing at least a first electronic noncontacting magnetic sensor, the at least first electronic noncontacting magnetic sensor integrated on an operation electronic control board having a control board plane, the operation electronic control board in electrical communication with the magnetic field generator and the control board plane oriented relative to the magnetic target, wherein the at least a first electronic noncontacting magnetic sensor provides a detected measured position of the magnetic target with the controllable field strength generated in relationship to the detected measured position sensed by the at least first electronic noncontacting magnetic sensor.

In an embodiment the invention includes a controllable brake comprising a housing comprising a rotor chamber and a sensor chamber, a shaft, the shaft extending through the rotor chamber and the sensor chamber with an axis of rotation, the shaft having a shaft end, a controllable brake rotor made integral with the shaft, the rotor housed in the rotor chamber, the rotor having a rotation plane, a controllable brake magnetic field generator located in the rotor chamber proximate the controllable brake rotor, the controllable brake magnetic field generator for generating a controllable magnetic field strength, and a controllable brake rotating magnetic target proximate the shaft end, the controllable brake rotating magnetic target housed in the sensor chamber, and a controllable brake first electronic noncontacting magnetic sensor having a first sensor plane, the first electronic noncontacting magnetic sensor mounted in the sensor chamber with the first sensor plane parallel with the controllable brake rotor rotation plane, the first electronic noncontacting magnetic sensor monitoring the rotation of the controllable brake rotating magnetic target and the controllable brake rotor and simultaneously outputting at least two rotational positions of the controllable brake rotor wherein the controllable magnetic field strength generated by the controllable brake magnetic field generator is determined with the rotational positions to control a relative motion of the controllable brake rotor.

In an embodiment the electronic noncontacting magnetic sensor preferably comprises an integrated circuit semiconductor sensor chip with at least two positional outputs. Preferably the electronic noncontacting magnetic sensor integrated circuit semiconductor sensor chip has at least two dies. Preferably the at least two dies are ASICs (Application Specific Integrated Circuits). In a preferred embodiment the at least two dies are side by side dies in the integrated circuit semiconductor sensor chip. In a preferred embodiment the at least two dies are vertically stacked dies in the integrated circuit semiconductor sensor chip. In a preferred embodiment the integrated circuit semiconductor sensor chip ASIC die include a magnetoresistive material, preferably with electrical resistance changes in the presence of the magnetic target magnetic field, preferably with magnetoresistive elements arranged in a Wheatstone bridge. In a preferred embodiment the integrated circuit semiconductor sensor chip ASIC die include a Hall Effect element, preferably a plurality of oriented Hall Effect elements, preferably silicon semiconductor Hall effect elements which detect the magnetic target magnetic field.

It is to be understood that both the foregoing general description and the following detailed description are exemplary of the invention, and are intended to provide an overview or framework for understanding the nature and character of the invention as it is claimed. The accompanying drawings are included to provide a further understanding of the invention, and are incorporated in and constitute a part of this specification. The drawings illustrate various embodiments of the invention, and together with the description serve to explain the principals and operation of the invention.

### BRIEF DESCRIPTION OF THE DRAWINGS

FIG. 1A-B show cross section views of a controllable brake.

FIG. 2A-B show cross section views of a controllable brake.

FIG. 2C shows a view of a controllable brake with the circuit board illustrated transparently to show electronic noncontacting magnetic sensors oriented on both sides of the circuit board.

FIG. 3 shows a controllable brake system schematic.

FIG. 4 shows four positional outputs for a controllable brake with two oriented electronic noncontacting magnetic sensors.

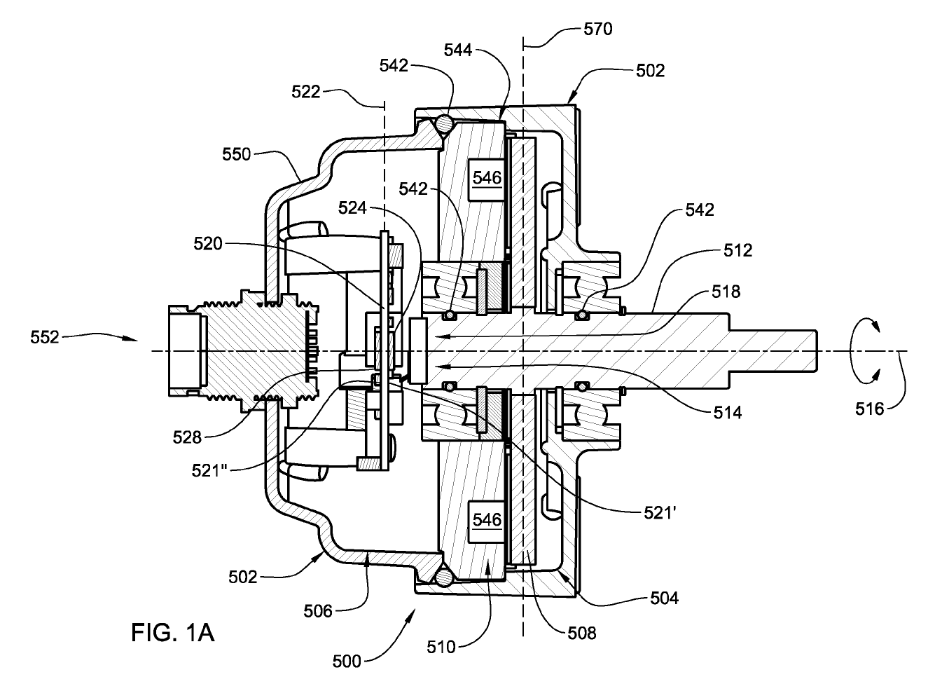

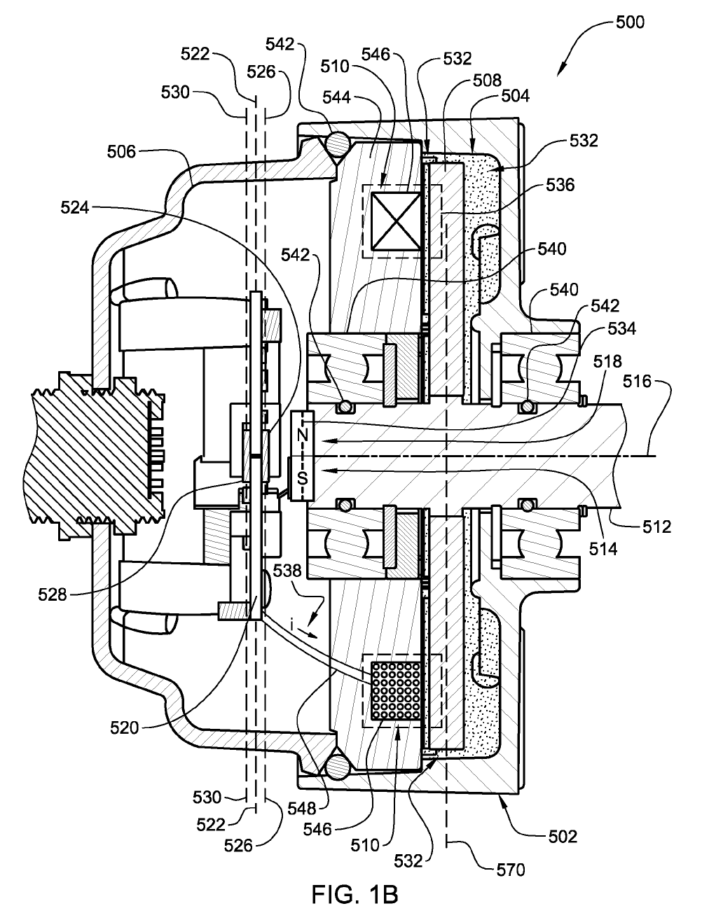

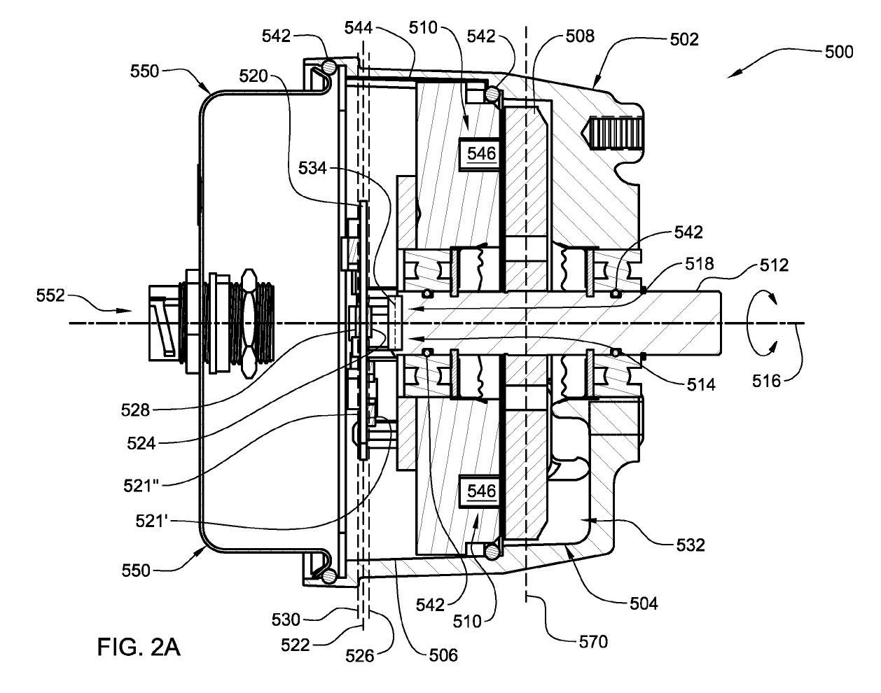

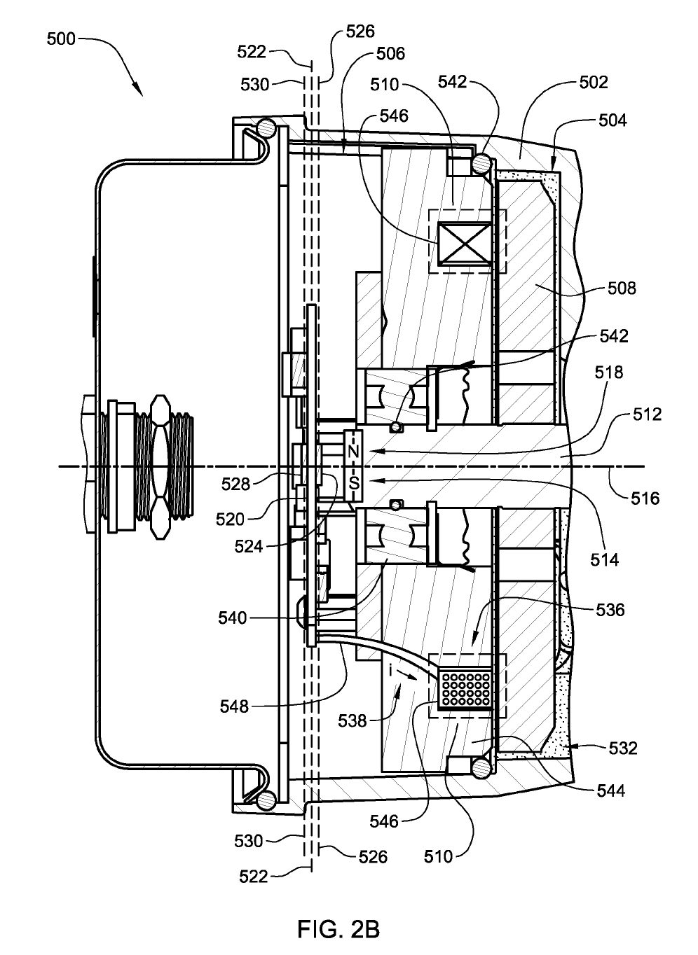

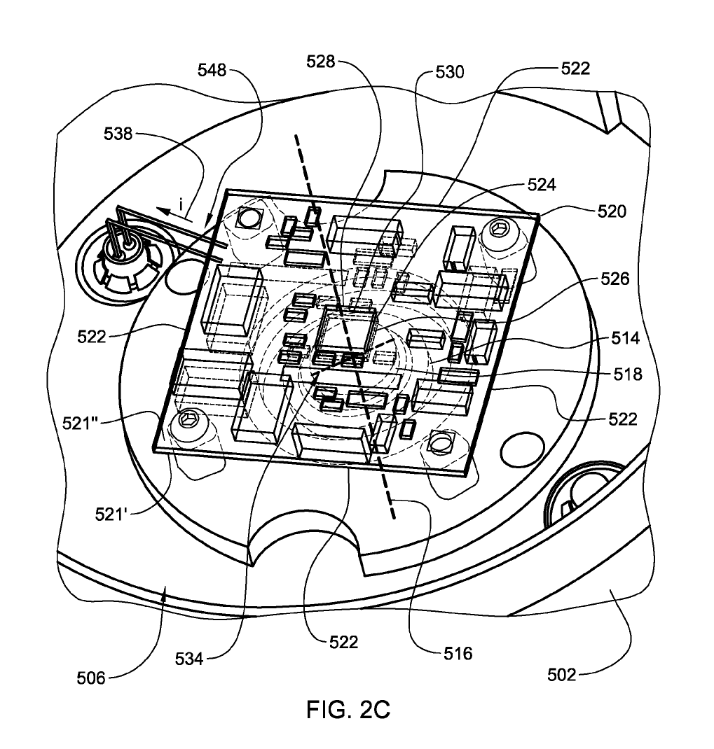

### DETAILED DESCRIPTION OF THE PREFERRED EMBODIMENT

Additional features and advantages of the invention will be set forth in the detailed description which follows, and in part will be readily apparent to those skilled in the art from that description or recognized by practicing the invention as described herein, including the detailed description which follows, the claims, as well as the appended drawings.

Reference will now be made in detail to the present preferred embodiments of the invention, examples of which are illustrated in the accompanying drawings.

In an embodiment the invention includes a controllable brake. The controllable brake preferably includes a housing including a first chamber and a second chamber. The controllable brake preferably includes a shaft, the shaft extending through the first chamber and the second chamber with an axis of rotation, the shaft having a first shaft end. The controllable brake preferably includes a controllable brake rotor made integral with the shaft, the rotor housed in the first chamber, with the rotor having a rotation plane preferably normal to the axis of rotation. The controllable brake preferably includes a controllable brake magnetic field generator located in the first chamber proximate the controllable brake rotor, the controllable brake magnetic field generator for generating a controllable magnetic field strength. The controllable brake preferably includes a controllable brake rotating magnetic target integrated with the shaft proximate the first shaft end, the controllable brake rotating magnetic target housed in the second chamber. The controllable brake preferably includes a controllable brake electronics circuit board mounted in the second chamber, the controllable brake electronics circuit board having a control board plane, the control board plane oriented normal to the shaft axis of rotation. The controllable brake preferably includes a first electronic noncontacting magnetic sensor having a first sensor plane, the first electronic noncontacting magnetic sensor integrated on the controllable brake electronics circuit board with the first sensor plane parallel with the control board plane. The controllable brake preferably includes a second electronic noncontacting magnetic sensor having a second sensor plane, the second electronic noncontacting magnetic sensor integrated on the controllable brake electronics circuit board with the second sensor plane parallel with the control board plane with the control board plane between the first sensor plane and the second sensor plane, the first electronic noncontacting magnetic sensor and the second electronic noncontacting magnetic sensor monitoring the rotation of the controllable brake rotating magnetic target and outputting a rotational position of the controllable brake rotating magnetic target wherein the controllable magnetic field strength generated by the controllable brake magnetic field generator is determined by the rotational position to control a relative motion of the controllable brake rotor.

In preferred embodiments the electronic noncontacting magnetic sensors preferably comprise integrated circuit semiconductor sensor chips with at least two positional outputs. Preferably the electronic noncontacting magnetic sensor integrated circuit semiconductor sensor chip has at least two dies. Preferably the at least two dies are ASICs (Application Specific Integrated Circuits). In a preferred embodiment the at least two dies are side by side dies in the integrated circuit semiconductor sensor chip. In a preferred embodiment the at least two dies are vertically stacked dies in the integrated circuit semiconductor sensor chip. In a preferred embodiment the integrated circuit semiconductor sensor chip ASIC die include a magnetoresistive material, preferably with electrical resistance changes in the presence of the magnetic target magnetic field, preferably with magnetoresistive elements arranged in a Wheatstone bridge. In a preferred embodiment the integrated circuit semiconductor sensor chip ASIC die include a Hall Effect element, preferably a plurality of oriented Hall Effect elements, preferably silicon semiconductor Hall effect elements which detect the magnetic target magnetic field.

The controllable brake 500 preferably includes a housing 502. The housing 502 preferably includes a first sealed chamber 504 and a second sealed chamber 506. The controllable brake preferably includes a shaft 512 with an axis of rotation 516 and a first shaft end 514. Preferably the shaft extends through the first sealed chamber and the second sealed chamber. The controllable brake 500 preferably includes a controllable brake rotor 508 made integral with the shaft, with the rotor 508 housed in the first sealed chamber 504, with the rotor 508 having a rotation plane 570 preferably normal to the axis of rotation 516. The controllable brake 500 preferably includes a controllable brake magnetic field generator 510 located in the first chamber proximate the controllable brake rotor 508, the controllable brake magnetic field generator for generating a controllable magnetic field strength. The controllable brake preferably includes a controllable brake rotating magnetic target 518 made integral with the shaft proximate the first shaft end 514 with the controllable brake rotating magnetic target 518 housed in the second sealed chamber, and a controllable brake electronics circuit board 520 mounted in the second sealed chamber. Preferably the brake operation electronics control board 520 controls and/or monitors the operation of the controllable brake 500. The controllable brake electronics circuit board 520 having a control board plane 522, the control board plane 522 oriented normal to the axis of rotation 516, a first electronic noncontacting magnetic sensor 524 having a first sensor plane 526, the first electronic noncontacting magnetic sensor 524 integrated on the controllable brake electronics circuit board 520 with the first sensor plane 526 parallel with the control board plane 522, and a second electronic noncontacting magnetic sensor 528 having a second sensor plane 530, the second electronic noncontacting magnetic sensor 528 integrated on the controllable brake electronics circuit board 520 with the second sensor plane 530 parallel with the control board plane 522 with the control board plane 522 between the first sensor plane 526 and the second sensor plane 530, the first electronic noncontacting magnetic sensor 524 and the second electronic noncontacting magnetic sensor 528 monitoring the rotation of the controllable brake rotating magnetic target 518 and outputting a rotational position of the controllable brake rotating magnetic target wherein the controllable magnetic field strength generated by the controllable brake magnetic field generator 510 is determined by the rotational position to control a relative motion of the controllable brake rotor 508. The controllable brake preferably includes a field responsive controllable material 532 sealed in the first chamber 504, preferably with the rheology of the field responsive controllable material being affected by the magnetic field generator 510. Preferably the electronic noncontacting magnetic sensors 524, 528 monitor the rotation of the rotating magnetic target 518, preferably with the magnetic sensors 524, 528 oriented and mounted relative to the shaft end 514 and its axis of rotation 516. Preferably the electronic noncontacting magnetic sensors 524, 528 are substantially planar sensors, with their sensor plane normal to axis of rotation 516, with the axis 516 centrally intersecting the sensing centers of the sensors 524, 528 with the sensor's sensing centers aligned with the axis 516. Preferably the magnetic target 518 is at the end of the shaft, preferably with the magnetic target 518 comprised of a magnet with north and south poles oriented relative and normal to the shaft axis of rotation 516 with the opposed N and S poles separated by the axis of rotation 516. Preferably the field responsive controllable material 532 is comprised of magnetic metal ferrous particles and lubricant, preferably dry ferrous particles and dry lubricant (preferably dry molybdenum disulfide). Preferably the controllable brake rotating magnetic target 518 is a permanent magnet with a north pole (N) and a south pole (S) opposed along a north south axis 534, with the north south axis 534 perpendicular with the shaft axis of rotation 516. Preferably the controllable brake 500 includes field responsive controllable material 532 sealed in the first chamber 504, with the field responsive controllable material 532 being affected by the controllable magnetic field strength, and the magnetic field generator 510 is adapted to generate a magnetic flux in a direction through the field responsive controllable material 532 towards the rotor 508, and the controllable brake electronics circuit board 520 provides a controlled current to the magnetic field generator 510. Preferably the controllable brake 500 includes a field responsive controllable material 532 sealed in the first chamber 504 with a rheology of the field responsive controllable material 532 being affected by the controllable magnetic field strength, and the magnetic field generator 510 is adapted to generate a magnetic flux 536 in a direction through the field responsive controllable material 532 towards the rotor 508, and the controllable brake electronics circuit board 520 provides a controlled current 538 to the magnetic field generator 510. Preferably the controllable brake shaft 512 is supported for rotation about axis 516 by bearings 540 in the housing 502, and further including seals 542 for sealing the first chamber to retain the controllable material 532 therein, preferably with the first and second chambers sealed from each other with the seals 542 and the housing members to provide the first and second separate sealed chambers 504,506, preferably with the field generator 510, including a pole piece member 544 which provides for both the generation of a magnetic field with an electromagnetic coil 546 and a housing divider for separating the housing 502 into the first and second chambers. Preferably the magnetic field generator 510 includes an electromagnetic coil 546 and the controllable brake electronics circuit board 520 is electrically connected with the magnetic field generator electromagnetic coil 546, preferably with electrical contact connections leads 548 to the EM coil 546. Preferably the electronics circuit board 520 provides a current 538 (i) to EM coil 546, for applying magnetic field flux 536 whose strength is determined by the rotational position of the rotor 508, with the magnetic target 518 rotation angle sensed by the sensors 524, 528. In a preferred embodiment at least one of the electronic noncontacting magnetic sensors 524,528 include a magnetoresistive material, preferably with electrical resistance changes in the presence of the magnetic target 518 magnetic field, preferably with magnetoresistive elements arranged in a Wheatstone bridge. In a preferred embodiment at least one of the electronic noncontacting magnetic sensors 524,528 includes a Hall Effect element, preferably a plurality of oriented Hall Effect elements, preferably silicon semiconductor Hall effect elements.

In a preferred embodiment the electronic noncontacting magnetic sensor includes a magnetoresistive material, preferably with electrical resistance changes in presence of a sensed magnetic field, preferably with magnetoresistive elements arranged in a Wheatstone bridge integrated circuit sensor chip with a planar format providing a sensor plane. In a preferred embodiment the electronic noncontacting magnetic sensor includes a Hall Effect element, preferably a plurality of oriented Hall Effect elements, preferably silicon semiconductor Hall effect elements arranged in an integrated circuit sensor chip with a planar format providing a sensor plane.

In an embodiment the invention includes a controllable brake. The controllable brake preferably includes a rotating magnetic target. The controllable brake preferably includes a magnetically permeable rotor. The controllable brake preferably includes a shaft connected to the magnetically permeable rotor. The controllable brake preferably includes a housing having a first housing chamber rotatably housing the magnetically permeable rotor therein, and including a magnetic field generator spaced from the magnetically permeable rotor, and configured and positioned for generating a controllable magnetic field to control a relative motion of the magnetically permeable rotor, and a second housing chamber containing control electronics therein, the second housing chamber electronics including at least a first oriented electronic noncontacting magnetic sensor, the at least first oriented electronic noncontacting magnetic sensor oriented relative to the rotating magnetic target and the shaft wherein the at least first oriented electronic noncontacting magnetic sensor monitors the rotation of the rotating magnetic target.

Preferably the controllable brake 500 includes rotating magnetic target 518. The controllable brake 500 preferably includes magnetically permeable rotor 508. The controllable brake preferably includes shaft 512 connected to the magnetically permeable rotor 508. The controllable brake preferably includes housing 502 having a first housing chamber 504 rotatably housing the magnetically permeable rotor 508 therein, and including a magnetic field generator 510 spaced from the magnetically permeable rotor 508, and configured and positioned for generating a controllable magnetic field 536 to control a relative motion of the magnetically permeable rotor 508, and a second housing chamber 506 containing control electronics 520 therein, the second housing chamber electronics 520 including at least a first oriented electronic noncontacting magnetic sensor 524, the at least first oriented electronic noncontacting magnetic sensor oriented relative to the rotating magnetic target 518 and the shaft 512 wherein the at least first oriented electronic noncontacting magnetic sensor monitors the rotation of the rotating magnetic target 518. Preferably the brake includes a controllable material 532, preferably contained in the first chamber 504 between and preferably filling the space between the magnetically permeable rotor 508 and the magnetic field generator 510 with the magnetic field generator spaced from the magnetically permeable rotor with the controllable material in-between the two with the two configured and positioned for generating a controllable magnetic field 536 to control the relative motion of the magnetically permeable rotor 508 relative to the magnetic field generator 510 with the magnetic field flux 536 through the controllable material 532 sealed in the first chamber between the magnetically permeable rotor and magnetic field generator controlling the relative motion. Preferably the at least first electronic noncontacting magnetic sensor provides a detected measured rotational position of the rotor, and the circuit board 520 control electronics are electrically connected with the magnetic field generator 510 and provide electrical control of the magnetic field generator 510 to apply a magnetic field 536 whose strength is determined by the detected measured rotational position of the rotor. Preferably the circuit board 520 control electronics electrical contact connections leads 548 deliver a current 538 to the EM coil 546, preferably with the electronics circuit board providing current i to EM coil 546 for applying magnetic field 536 whose strength is determined by the relative rotational position of the rotor 508 as the magnetic target rotation angle sensed by the at least one noncontact oriented sensor. Preferably the at least first oriented electronic noncontacting magnetic sensor is integrated into brake operation electronics control board 520 mounted in the second sealed chamber 506 wherein the brake operation electronics control board 520 controls the operation of the controllable brake 500. Preferably the noncontacting magnetic sensor has a sensor plane 526, 530 oriented with the shaft axis of rotation 516, preferably with the sensor plane parallel with control board plane 522 with such normal to shaft axis of rotation 516, with the rotation axis 516 intersecting the sensor plane proximate the sensing center of the noncontacting magnetic sensor. Preferably the controllable brake 500 includes a second oriented electronic noncontacting magnetic sensor 528, wherein the first electronic noncontacting magnetic sensor 524 and the second electronic noncontacting magnetic sensor 528 are integrated into brake operation electronics control board 520 mounted in the second sealed chamber 506 wherein the brake operation electronics control board 520 controls and/or monitors the operation of the controllable brake 500. Preferably the at least first and second magnetic sensors 524, 528 have a sensor planes oriented with the shaft axis of rotation 516, preferably with the sensor planes parallel with control board plane 522, with such planes normal to shaft axis of rotation, with the control board plane 522 between the first and second sensor planes 526 and 530. Preferably the brake operation electronics control circuit board 520 has a less than one millimeter thickness between the first oriented electronic noncontacting magnetic sensor 524 and the second oriented electronic noncontacting magnetic sensor 528, and the rotating magnetic target 518 is comprised a shaft oriented permanent magnet, preferably with permanent magnet N-S pole axis 534. Preferably the magnetic sensors have sensor planes oriented with the shaft axis of rotation 516, preferably with the sensor planes parallel with the control board plane, with such normal to the shaft axis of rotation, with the control board plane of the less than one millimeter thickness circuit board between the first and second sensor planes.

In an embodiment the invention includes a method of controlling motion. The method preferably includes providing a housing having a first housing chamber and a second housing chamber. The method preferably includes providing a shaft with a magnetically permeable rotor, the shaft including a rotating magnetic target distal from the magnetically permeable rotor. The method preferably includes providing a magnetic field generator for generating a magnetic field with a controllable field strength for controlling a relative motion of the magnetically permeable rotor. The method preferably includes providing at least a first electronic noncontacting magnetic sensor, the at least first electronic noncontacting magnetic sensor integrated on an operation electronic control board having a control board plane. The method preferably includes disposing the magnetically permeable rotor and the magnetic field generator in the first housing chamber. The method preferably includes disposing the rotating magnetic target and the at least a first electronic noncontacting magnetic sensor in the second housing chamber, wherein the operation electronic control board is in electrical communication with the magnetic field generator and the control board plane is oriented relative to the rotating magnetic target, wherein the at least first electronic noncontacting magnetic sensor provides a detected measured rotational position of the rotating magnetic target with the controllable field strength generated in relationship to the detected measured rotational position sensed by the at least first electronic noncontacting magnetic sensor.

Preferably the controlling motion method includes providing a housing 502 having a first housing chamber 504 and a second housing chamber 506. Preferably the controlling motion method includes providing a shaft 512 with a magnetically permeable rotor 508, with the shaft including a rotating magnetic target 518 distal from the magnetically permeable rotor 508. Preferably the controlling motion method includes providing a magnetic field generator 510 for generating a magnetic field with a controllable field strength for controlling a relative motion of the magnetically permeable rotor. Preferably the controlling motion method includes providing a field responsive controllable material, with the field responsive controllable material affected by the magnetic field generator magnetic field. Preferably the provided field responsive controllable material has a rheology which is controllable by the generated magnetic field, preferably with a field responsive controllable material 532 provided from magnetic metal ferrous particles and lubricant, preferably dry ferrous particles and dry lubricant (preferably dry molybdenum disulfide lubricant). Preferably the controlling motion method includes providing at least a first electronic noncontacting magnetic sensor 524, 528. Preferably the at least first electronic noncontacting magnetic sensor is integrated on an operation electronic control board 520 having a control board plane 522. Preferably the controlling motion method includes disposing the magnetically permeable rotor, the magnetic field generator, in the first housing chamber. Preferably disposing the magnetically permeable rotor, the magnetic field generator, in the first housing chamber includes sealing such therein along with the field responsive controllable material 532. Preferably the controlling motion method includes disposing the rotating magnetic target 518 and the at least a first electronic noncontacting magnetic sensor in the second housing chamber 506, wherein the operation electronic control board 520 is in electrical communication with the magnetic field generator 510 and the control board plane 522 is oriented relative to the rotating magnetic target 518, wherein the at least first electronic noncontacting magnetic sensor provides a detected measured rotational position of the rotating magnetic target with the controllable field strength generated in relationship to the detected measured rotational position sensed by the at least first electronic noncontacting magnetic sensor. Preferably the at least first electronic noncontacting magnetic sensor has the sensor plane (526, 530) oriented with the control board plane 522. Preferably the sensor plane (526,530) is parallel with control board plane 522, with such normal to shaft axis of rotation 516, with rotation axis 516 intersecting the sensor plane proximate the sensing center of the sensor. Preferably the method includes providing a second electronic noncontacting magnetic sensor with a sensor plane (526, 530) with the second electronic noncontacting magnetic sensor integrated on the operation electronic control board with the second electronic noncontacting magnetic sensor plane oriented parallel with the control board plane, with the control board plane between the second electronic noncontacting magnetic sensor plane and the first electronic noncontacting magnetic sensor plane. In an embodiment preferably at least one of the electronic noncontacting magnetic sensor includes a magnetoresistive material, preferably with electrical resistance changes in presence of the target magnetic field, preferably with magnetoresistive elements arranged in a Wheatstone bridge. In an embodiment preferably at least one of the electronic noncontacting magnetic sensor includes a Hall Effect element, preferably a plurality of oriented Hall Effect elements, preferably silicon semiconductor Hall effect elements for sensing shaft rotational changes of the target magnetic field.

In an embodiment the invention includes a method of making a motion control brake for controlling motion. The method preferably includes providing a magnetic field generator for generating a magnetic field with a controllable field strength for controlling a relative motion of a movable brake member. The method preferably includes providing a magnetic target which moves with the relative motion of the movable brake member. The method preferably includes providing an electronic circuit board having a circuit board plane, a first oriented electronic noncontacting magnetic sensor having a first oriented sensor plane, the first electronic noncontacting magnetic sensor integrated on the electronic circuit board with the first sensor plane parallel with the circuit board plane, a second oriented electronic noncontacting magnetic sensor having a second oriented sensor plane, the second electronic noncontacting magnetic sensor integrated on the electronic circuit board with the second sensor plane parallel with the circuit board plane with the circuit board plane between the second sensor plane and the first sensor plane. The method preferably includes disposing the electronic circuit board proximate the magnetic target wherein the first electronic noncontacting magnetic sensor and the second electronic noncontacting magnetic sensor provide a detected measured magnetic target position with the controllable field strength generated by the magnetic field generator determined by the detected measured magnetic target position.

Preferably the method of making a motion control brake 500 includes providing a magnetic field generator 510 for generating a magnetic field 536 with a controllable field strength for controlling a relative motion of a movable brake member 508. The method preferably includes providing a magnetic target 518 which moves with the relative motion of the movable brake member 508. The method preferably includes providing an electronic circuit board 520 having a circuit board plane 522, a first oriented electronic noncontacting magnetic sensor 524 having a first oriented sensor plane 526, the first electronic noncontacting magnetic sensor 524 integrated on the electronic circuit board 520 with the first sensor plane 526 parallel with the circuit board plane 522, a second oriented electronic noncontacting magnetic sensor 528 having a second oriented sensor plane 530, the second electronic noncontacting magnetic sensor 528 integrated on the electronic circuit board 520 with the second sensor plane 530 parallel with the circuit board plane 522 with the circuit board plane 522 between the second sensor plane 530 and the first sensor plane 526. The method preferably includes disposing the electronic circuit board 520 proximate the magnetic target 518 wherein the first electronic noncontacting magnetic sensor 524 and the second electronic noncontacting magnetic sensor 528 provide a detected measured magnetic target position with the controllable field strength generated by the magnetic field generator 510 determined by the detected measured magnetic target position. Preferably the movable brake member is comprised of a movable brake rotor 508, preferably with a shaft 512 having a distal end permanent magnet magnetic target 518 which moves with the relative motion of the movable brake rotor. Preferably the electronic circuit board first integrated oriented electronic noncontacting magnetic sensor 524 and its first oriented sensor plane parallel with the circuit board plane and the second integrated oriented electronic noncontacting magnetic sensor 528 with its second oriented sensor plane parallel with the circuit board plane with the circuit board plane between the second sensor plane and the first sensor plane, with the method including the integrating and orienting the two sensors overlappingly on both planar sides of the circuit board 520. Preferably the overlapping integrated and oriented sensors and in between circuit board are disposed proximate the magnetic target 518 wherein the first electronic noncontacting magnetic sensor 524 and the second electronic noncontacting magnetic sensor 528 provide a detected measured magnetic target position with the controllable field strength generated by the magnetic field generator 510 determined by the detected measured magnetic target position. The method preferably includes providing a shaft 512 with the movable brake member comprising rotor 508 and the magnetic target 518 includes a permanent magnet with a north pole and a south pole opposed along a north south axis 534, preferably with the north south axis 534 perpendicular with the shaft axis of rotation 516, preferably with the movable brake member rotor 508 made integral with the shaft 512 and the magnetic target permanent magnet 518 made integral with the shaft. Preferably the integrating the shaft and rotor includes connecting the rotor with the shaft in a manner to restrain relative rotation there between. Preferably the shaft, the movable brake member rotor, and the magnetic target permanent magnet have an axis of rotation 516 with the circuit board plane 522 oriented normal to the axis of rotation 516 with the axis of rotation going through the sensor centers, preferably with the north south axis 534 perpendicular with the shaft axis of rotation 516. Preferably the electronic circuit board 520 has a less than one millimeter thickness between the first oriented electronic noncontacting magnetic sensor 524 and the second oriented electronic noncontacting magnetic sensor 528, and preferably the rotating magnetic target 518 is comprised of a shaft oriented permanent magnet. Preferably the first electronic noncontacting magnetic sensor 524 and the second electronic noncontacting magnetic sensor 528 provide the circuit board with at least a first position output, at least a second position output, and at least a third position output, and most preferably four simultaneously detected position outputs, with the motion control brake method/system including a position output processor for processing the multiply position outputs, preferably with the position output processor comparing the multiply outputs to determine if there is a suspected error output and exclude such suspected error output from the determination of the magnetic field generated to actively control motion with the brake. Preferably the controllable brake provides a multiply redundancy controllable brake sensor system with the brake sensors at least three simultaneously sensed positions outputs monitored and compared for suspected error output, with error outputs excluded from the electronic control system determination of controlling the applied magnetic field to control the relative motion allowed by the brake, either within an inner control loop operating within the brake or an outer control loop within which the brake is integrated to provide the brake's control of motion and outputted target sensed positions. In an embodiment the electronic noncontacting magnetic sensors include magnetoresistive materials with electrical resistance changes in the presence of the magnetic target magnetic field, preferably with sensor magnetoresistive elements arranged in a Wheatstone bridge to sense the rotating magnetic field of the magnetic targets pole axis 534. In an embodiment the electronic noncontacting magnetic sensors include a Hall Effect element, preferably a plurality of oriented Hall Effect elements, preferably silicon semiconductor Hall effect elements integrated together to sense the rotating magnetic field of the magnetic targets pole axis 534.

In an embodiment the invention includes a method of making a control system. The method preferably includes providing a control system rotating magnetic target having an axis of rotation. The method preferably includes providing a control system electronic circuit board having a circuit board plane and a first circuit board side and an opposite second circuit board side, a first oriented electronic noncontacting magnetic sensor integrated on the electronic circuit board first circuit board side, a second oriented electronic noncontacting magnetic sensor integrated on the electronic circuit board second circuit board side. The method preferably includes disposing the control system electronic circuit board proximate the control system rotating magnetic target with a projected extension of the axis of rotation extending through the first oriented electronic noncontacting magnetic sensor and the second oriented electronic noncontacting magnetic sensor wherein the first electronic noncontacting magnetic sensor and the second electronic noncontacting magnetic sensor provide a plurality of detected measured magnetic target rotary position outputs.

Preferably the method of making a control system includes providing a control system rotating magnetic target 518 having an axis of rotation 516. The method preferably includes providing a control system electronic circuit board 520 having a circuit board plane 522 and a first circuit board side 521′ and an opposite second circuit board side 521″, a first oriented electronic noncontacting magnetic sensor 524 integrated on the electronic circuit board first circuit board side 521′, a second oriented electronic noncontacting magnetic sensor 528 integrated on the electronic circuit board second circuit board side 521″. The method preferably includes disposing the control system electronic circuit board 520 proximate the control system rotating magnetic target 518 with a projected extension of the axis of rotation 516 extending through the first oriented electronic noncontacting magnetic sensor 524 and the second oriented electronic noncontacting magnetic sensor 528 wherein the first electronic noncontacting magnetic sensor 524 and the second electronic noncontacting magnetic sensor 528 provide a plurality of detected measured magnetic target rotary position outputs. Preferably the method includes integrating and orienting the two sensors overlappingly on both planar sides of the circuit board 520. Preferably overlapping, integrating and orienting the sensors on the circuit board such that the circuit board is mountable proximate the magnetic target 518 wherein the first electronic noncontacting magnetic sensor 524 and the second electronic noncontacting magnetic sensor 528 provide a plurality of simultaneously detected measured magnetic target position outputs. Preferably the magnetic target 518 includes a permanent magnet with a north pole and a south pole opposed along a north south axis 534 with the north south axis perpendicular with the axis of rotation 516, preferably with the overlapping, integrated oriented sensors 524, 528, preferably providing at least a first position output, at least a second position output, and at least a third position output, and most preferably four simultaneously detected position outputs, with the motion control system including a position output processor for processing the multiply position outputs, preferably with the position output processor comparing the multiply outputs to determine if there is a suspected error output and exclude such suspected error output from the control system process loop. Preferably the control system provides a multiply redundancy control sensor system with the sensors at least three simultaneously sensed positions outputs monitored and compared for suspected error output, with error outputs excluded from the electronic control system determination control loops (either within an inner control loop operating within the control system electronic circuit board 520 or an outer control loop within which the board is integrated into to provide the outputted target sensed positions). In an embodiment the electronic noncontacting magnetic sensors include magnetoresistive materials with electrical resistance changes in the presence of the magnetic target magnetic field, preferably with sensor magnetoresistive elements arranged in a Wheatstone bridge to sense the rotating magnetic field of the magnetic targets pole axis 534. In an embodiment the electronic noncontacting magnetic sensors include a Hall Effect element, preferably a plurality of oriented Hall Effect elements, preferably silicon semiconductor Hall effect elements integrated together to sense the rotating magnetic field of the magnetic targets pole axis 534. Preferably the electronic circuit board 520 has a less than one millimeter thickness between the first oriented electronic noncontacting magnetic sensor and the second oriented electronic noncontacting magnetic sensor, and preferably the rotating magnetic target includes a shaft oriented permanent magnet.

Preferably the first electronic noncontacting magnetic sensor and the second electronic noncontacting magnetic sensor provide the circuit board 520 with at least a first position output, at least a second position output, and at least a third position output, and preferably four simultaneously detected position outputs, with the motion control system including a position output processor for processing the multiply position outputs, which preferably compares the multiply outputs to determine if there is a suspected error output and exclude such suspected error output from the determination in a control system control loop step.

In an embodiment the invention includes a method of controlling motion. The method preferably includes providing a magnetic field generator for generating a magnetic field with a controllable field strength. The method preferably includes providing a field responsive controllable material, the field responsive controllable material affected by the magnetic field generator magnetic field. The method preferably includes providing a magnetic target. The method preferably includes providing at least a first electronic noncontacting magnetic sensor, the at least first electronic noncontacting magnetic sensor integrated on an operation electronic control board having a control board plane, the operation electronic control board in electrical communication with the magnetic field generator and the control board plane oriented relative to the magnetic target, wherein the at least a first electronic noncontacting magnetic sensor provides a detected measured position of the magnetic target with the controllable field strength generated in relationship to the detected measured position sensed by the at least first electronic noncontacting magnetic sensor.

Preferably the method of controlling motion includes providing a magnetic field generator 510 for generating a magnetic field 536 with a controllable field strength. The method preferably includes providing a field responsive controllable material 532, the field responsive controllable material affected by the magnetic field generator magnetic field. The method preferably includes providing a magnetic target 518. The method preferably includes providing at least a first electronic noncontacting magnetic sensor 524, the at least first electronic noncontacting magnetic sensor 524 integrated on an operation electronic control board 520 having a control board plane 522, the operation electronic control board 520 in electrical communication with the magnetic field generator 510 and the control board plane 522 oriented relative to the magnetic target 518, wherein the at least a first electronic noncontacting magnetic sensor 524 provides a detected measured position of the magnetic target 518 with the controllable field strength 536 generated in relationship to the detected measured position sensed by the at least first electronic noncontacting magnetic sensor 524. Preferably providing a field responsive controllable material 532 includes providing a material rheology which is field responsive, with the field responsive controllable material rheology affected and controllable by the magnetic field generator magnetic field 536, preferably the provided field responsive controllable material 532 is comprised of magnetic metal ferrous particles and lubricant, preferably dry ferrous particles and dry lubricant (preferably dry molybdenum disulfide). Preferably the provided magnetic target is a rotating magnetic target, that preferably provides a rotating magnetic field with the permanent magnet pole axis 534. Preferably the at least first electronic noncontacting magnetic sensors provide a detected measured rotational position of the magnetic target with the controllable magnetic field strength generated in relationship to the detected measured rotational position sensed by the at least first electronic noncontacting magnetic sensor. Preferably the at least first electronic noncontacting magnetic sensor 524 has a sensor plane 526 oriented with the control board plane 522. Preferably the at least first electronic noncontacting magnetic sensor plane 526 is oriented normal with the shaft axis of rotation 516. Preferably the sensor plane 526 is parallel with control board plane 522, with such normal to shaft axis of rotation 516, with the axis 516 intersecting sensor plane proximate the sensing center of the sensor 524. Preferably the method includes providing second electronic noncontacting magnetic sensor 528 with a sensor plane 530, with the second electronic noncontacting magnetic sensor 528 integrated on the operation electronic control board 520 with the second electronic noncontacting magnetic sensor plane 530 oriented parallel with the control board plane 522, with the control board plane 522 between the second electronic noncontacting magnetic sensor plane 530 and the first electronic noncontacting magnetic sensor plane 526. In an embodiment the electronic noncontacting magnetic sensors include magnetoresistive materials with electrical resistance changes in the presence of the magnetic target magnetic field, preferably with sensor magnetoresistive elements arranged in a Wheatstone bridge to sense the rotating magnetic field of the magnetic targets pole axis 534. In an embodiment the electronic noncontacting magnetic sensors include a Hall Effect element, preferably a plurality of oriented Hall Effect elements, preferably silicon semiconductor Hall effect elements integrated together to sense the rotating magnetic field of the magnetic targets pole axis 534.

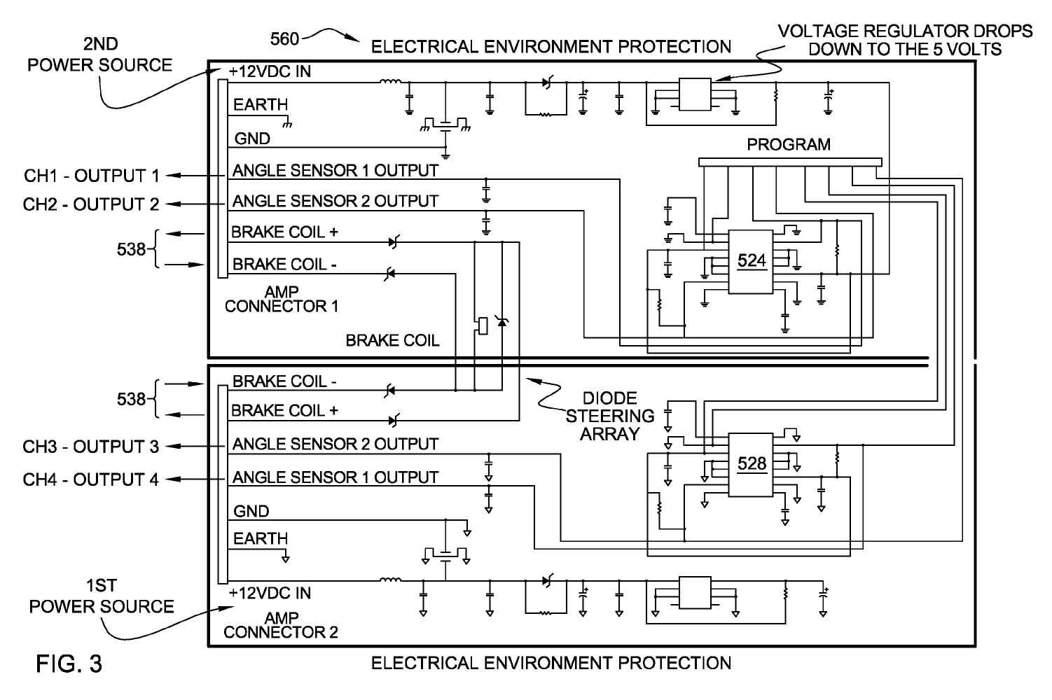

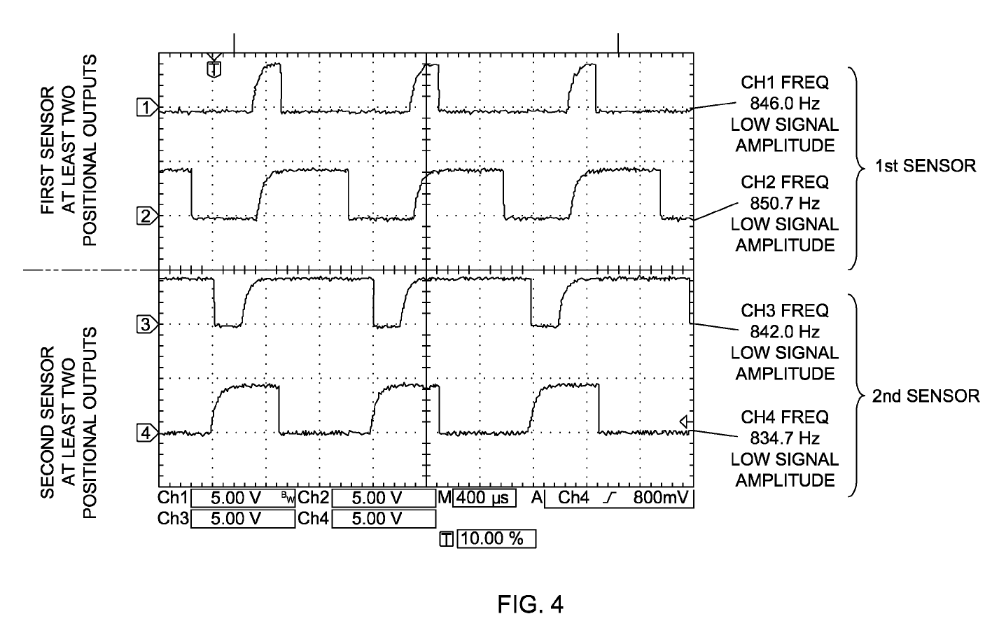

Preferably the circuit board 520 includes electrical environmental protection circuitry. Preferably the circuit board circuitry includes electrical environmental protection circuitry 560 such as shown in FIG. 3. Preferably the circuit board circuitry includes a voltage regulator which drops down a first supplied voltage to the board down to a lowered sensor voltage for the sensor, such as the LM2931 voltage regulator such as shown in FIG. 3 dropping down the 12 volt power down to the 5 volt power supplied to the sensors 524, 528. Preferably the electrical environmental protection circuitry includes an electromagnetic filter providing EMC filtering protection. Preferably the circuit board 520 includes a first and a second power source, with the circuit board controlling the supply, conditioning and distribution of electrical power from the at least two power sources, to provide a controlled current 538 to the brake coil 546. The circuit board 520 provides control, supply, conditioning and distribution of current to the sensors 524, 528 and the EM coil 546 of the field generator 510, and output sensed angular position data such as shown in FIG. 4. Additionally in an embodiment the control system includes an outer control loop with the EM coil controlled outside the inner loop utilizing the output sensed angular position data from the sensors and board control system, such as with the FIG. 4 output data used to determine and produce a control current to EM coil 546 to control a relative motion with the brake 500. Preferably the at least two power sources provide for power supply to the same sensor. In a preferred embodiment the first power supply provides power to both sensors, with a backup secondary power supplied to the sensors from the second power supply. In preferred embodiments the 12 volt power to the circuit board 520 and the outputted sensed angular position data from the sensors are provided through the electronics outer loop conduit utilizing two separate cables routing the wiring into the second chamber 506. Preferably two separate cabled power supplies are supplied to the double sided board 520, with the circuit board 520 providing two isolated power supplies to a sensor. Preferably two separate cabled power supplies are supplied to the double sided board 520, with the circuit board 520 including electronics to send power to the EM brake coil 546, preferably at least with a control current 538 provided such as with the current control flyback diode steer current from two isolated power supplies supplied to the brake EM coil 546. In a preferred embodiment the board includes a processor that determines on board with an inner loop in the brake 500 to provide the control current 538 to the EM coil 546 based on the sensed position of the magnetic target 518, preferably with a position output processor processing the multiply position outputs from the sensors, which preferably compares the multiply outputs to determine if there is a suspected error output and exclude such suspected error output from the determination in the system control loop step. Preferably one set of electrical contact connections 548 deliver the control current 538 to the EM coil from the diode steering array. As shown in FIG. 4, the integrated oriented first and second sensors provide four detected target positions, preferably providing the absolute angular position of the rotating magnetic target 518, the shaft 512, and the rotor 508, preferably with the four outputs monitored and compared to detect a suspected erroneous output which in turn is ignored and not utilized in the determination of controlling the motion of the rotor with the field generator 510. FIG. 4 shows the positional outputs from two integrated circuit semiconductor sensor chip electronic noncontacting magnetic sensors 524, 528 mounted to opposing sides of a circuit board 520 for detecting the rotation of the target 518, the shaft 512, and the rotor 508. Channels 1 and 2 (Ch1, Ch2) show the at least two positional outputs (Ch1, Ch2) for the first integrated circuit semiconductor sensor chip electronic noncontacting magnetic sensor. Channels 3 and 4 (Ch3, Ch4) show the at least two positional outputs (Ch3, Ch4) for the second integrated circuit semiconductor sensor chip electronic noncontacting magnetic sensor. In this embodiment each of the integrated circuit semiconductor sensor chip electronic noncontacting magnetic sensors provided simultaneously two positional outputs (Ch1, Ch2) and (Ch3, Ch4). Preferably the electronic noncontacting magnetic sensor integrated circuit semiconductor sensor chip has at least two dies. Preferably the at least two dies are ASICs (Application Specific Integrated Circuits). In a preferred embodiment the at least two dies are side by side dies in the integrated circuit semiconductor sensor chip. In a preferred embodiment the at least two dies are vertically stacked dies in the integrated circuit semiconductor sensor chip. In a preferred embodiment the integrated circuit semiconductor sensor chip ASIC die include a magnetoresistive material, preferably with electrical resistance changes relative to the rotating shaft magnetic target magnetic field, preferably with magnetoresistive elements arranged in a Wheatstone bridge. In a preferred embodiment the integrated circuit semiconductor sensor chip ASIC die include a Hall Effect element, preferably a plurality of oriented Hall Effect elements, preferably silicon semiconductor Hall effect elements which detect changes relative to the rotating magnetic target magnetic field of the rotating shaft magnetic target.

It will be apparent to those skilled in the art that various modifications and variations can be made to the invention without departing from the spirit and scope of the invention. Thus, it is intended that the invention cover the modifications and variations of this invention provided they come within the scope of the appended claims and their equivalents. It is intended that the scope of differing terms or phrases in the claims may be fulfilled by the same or different structure(s) or step(s).

1. A controllable brake comprising:
a housing comprising a first chamber and a second chamber,
a shaft, the shaft extending through the first chamber and the second chamber with an axis of rotation, said shaft having a first shaft end,
a controllable brake rotor made integral with the shaft, said rotor housed in the first chamber,
a controllable brake magnetic field generator located in the first chamber proximate the controllable brake rotor, said controllable brake magnetic field generator for generating a controllable magnetic field strength, and
a controllable brake rotating magnetic target integral with said shaft proximate said first shaft end, said controllable brake rotating magnetic target housed in the second chamber, and a controllable brake electronics circuit board mounted in said second chamber, said controllable brake electronics circuit board having a control board plane, said control board plane oriented normal to said axis of rotation, a first electronic noncontacting magnetic sensor having a first sensor plane, said first electronic noncontacting magnetic sensor integrated on said controllable brake electronics circuit board with said first sensor plane parallel with said control board plane, a second electronic noncontacting magnetic sensor having a second sensor plane, said second electronic noncontacting magnetic sensor integrated on said controllable brake electronics circuit board with said second sensor plane parallel with said control board plane with said control board plane between said first sensor plane and said second sensor plane, said first electronic noncontacting magnetic sensor and said second electronic noncontacting magnetic sensor monitoring the rotation of said controllable brake rotating magnetic target and outputting a rotational position of said controllable brake rotating magnetic target wherein the controllable magnetic field strength generated by said controllable brake magnetic field generator is determined by said rotational position to control a relative motion of said controllable brake rotor.

2. The controllable brake of claim 1, wherein said controllable brake rotating magnetic target is comprised of a permanent magnet with a north pole and a south pole opposed along a north south axis, said north south axis perpendicular with said shaft axis of rotation.

3. The controllable brake of claim 1, said controllable brake including a field responsive controllable material in said first chamber, said field responsive controllable material being affected by said controllable magnetic field strength, and said magnetic field generator is adapted to generate a magnetic flux in a direction through said field responsive controllable material towards said rotor.

4. The controllable brake of claim 1, said controllable brake including a field responsive controllable material sealed in said first chamber with a rheology of said field responsive controllable material being affected by said controllable magnetic field strength, and said magnetic field generator is adapted to generate a magnetic flux in a direction through said field responsive controllable material towards said rotor, and said controllable brake electronics circuit board provides a controlled current to said magnetic field generator.

5. The controllable brake of claim 1 wherein said magnetic field generator comprises an electromagnetic coil and said controllable brake electronics circuit board is electrically connected with said magnetic field generator electromagnetic coil.

6. The controllable brake of claim 1 wherein said electronic noncontacting magnetic sensor includes a magnetoresistive material.

7. The controllable brake of claim 1 wherein said electronic noncontacting magnetic sensor includes a Hall Effect element.

8. A controllable brake, comprising:
a rotating magnetic target,
a magnetically permeable rotor,
a shaft connected to said magnetically permeable rotor,
a housing having a first housing chamber rotatably housing the magnetically permeable rotor therein, and including a magnetic field generator spaced from the magnetically permeable rotor, and configured and positioned for generating a controllable magnetic field to control a relative motion of said magnetically permeable rotor, and a second housing chamber containing control electronics therein, said second housing chamber electronics including at least a first oriented electronic noncontacting magnetic sensor, said at least first oriented electronic noncontacting magnetic sensor oriented relative to said rotating magnetic target and said shaft wherein said at least first oriented electronic noncontacting magnetic sensor monitors the rotation of said rotating magnetic target.

9. The controllable brake of claim 8, wherein said at least first electronic noncontacting magnetic sensor provides at least two detected measured rotor positional outputs, and said at least two outputs used in a computational determination for applying a controlled magnetic field strength.

10. The controllable brake of claim 9, wherein said at least first oriented electronic noncontacting magnetic sensor is integrated into a brake operation electronics control board mounted in said second sealed chamber wherein said brake operation electronics control board controls the operation of said controllable brake.

11. The controllable brake of claim 9, including a second oriented electronic noncontacting magnetic sensor, wherein said first electronic noncontacting magnetic sensor and said second electronic noncontacting magnetic sensor are integrated into a brake operation electronics control board mounted in said second sealed chamber wherein said brake operation electronics control board controls and/or monitors the operation of said controllable brake.

12. The controllable brake of claim 11, wherein said brake operation electronics control board has a less than one millimeter thickness between said first oriented electronic noncontacting magnetic sensor and said second oriented electronic noncontacting magnetic sensor, and said rotating magnetic target is comprised of a shaft oriented permanent magnet.

13. A method of controlling motion, said method including:
providing a housing having a first housing chamber and a second housing chamber,
providing a shaft with a magnetically permeable rotor, said shaft including a rotating magnetic target distal from said magnetically permeable rotor,
providing a magnetic field generator for generating a magnetic field with a controllable field strength for controlling a relative motion of said magnetically permeable rotor,
providing at least a first electronic noncontacting magnetic sensor, said at least first electronic noncontacting magnetic sensor integrated on an operation electronic control board having a control board plane,
disposing said magnetically permeable rotor, said magnetic field generator, in said first housing chamber,
disposing said rotating magnetic target and said at least first electronic noncontacting magnetic sensor in said second housing chamber, wherein said operation electronic control board is in electrical communication with said magnetic field generator and said control board plane is oriented relative to said rotating magnetic target, wherein said at least first electronic noncontacting magnetic sensor provides a detected measured rotational position of said rotating magnetic target with said controllable field strength generated in relationship to the detected measured rotational position sensed by said at least first electronic noncontacting magnetic sensor.

14. A method as claimed in claim 13, said at least first electronic noncontacting magnetic sensor having a sensor plane oriented with said control board plane.

15. A method as claimed in claim 14, said method including providing a second electronic noncontacting magnetic sensor with a sensor plane, said second electronic noncontacting magnetic sensor integrated on said operation electronic control board with said second electronic noncontacting magnetic sensor plane oriented parallel with said control board plane, with said control board plane between said second electronic noncontacting magnetic sensor plane and said first electronic noncontacting magnetic sensor plane.

16. A method as claimed in claim 13, wherein said at least first electronic noncontacting magnetic sensor includes a magnetoresistive material.

17. A method as claimed in claim 13, wherein said at least first electronic noncontacting magnetic sensor includes a Hall Effect element.

18. A method of making a motion control brake for controlling motion, said method including,
providing a magnetic field generator for generating a magnetic field with a controllable field strength for controlling a relative motion of a movable brake member,
providing a magnetic target which moves with said relative motion of said movable brake member,
providing an electronic circuit board having a circuit board plane, a first electronic noncontacting magnetic sensor having a first sensor plane, said first electronic noncontacting magnetic sensor integrated on said electronic circuit board with said first sensor plane parallel with said circuit board plane, a second electronic noncontacting magnetic sensor having a second sensor plane, said second electronic noncontacting magnetic sensor integrated on said electronic circuit board with said second sensor plane parallel with said circuit board plane with said circuit board plane between said second sensor plane and said first sensor plane,
disposing said electronic circuit board proximate said magnetic target wherein said first electronic noncontacting magnetic sensor and said second electronic noncontacting magnetic sensor provide a detected measured magnetic target position with the controllable field strength generated by said magnetic field generator determined by the detected measured magnetic target position.

19. A method as claimed in claim 18, including providing a shaft wherein said movable brake member is comprised of a rotor and said magnetic target is comprised of a permanent magnet with a north pole and a south pole opposed along a north south axis with said movable brake member rotor made integral with said shaft and said magnetic target permanent magnet made integral with said shaft.

20. A method as claimed in claim 19, wherein said shaft, said movable brake member rotor, and said magnetic target permanent magnet have an axis of rotation with said circuit board plane oriented normal to said axis of rotation.

21. A method as claimed in claim 18 wherein said electronic circuit board has a less than one millimeter thickness between said first electronic noncontacting magnetic sensor and said second electronic noncontacting magnetic sensor.

22. A method as claimed in claim 18 wherein said first electronic noncontacting magnetic sensor and said second electronic noncontacting magnetic sensor provide at least a first position output, at least a second position output, and at least a third position output.

23. A method as claimed in claim 18, wherein said electronic noncontacting magnetic sensor includes a magnetoresistive material.

24. A method as claimed in claim 18, wherein said electronic noncontacting magnetic sensor includes a Hall Effect element.

25. A method of making a control system, said method including,
providing a control system rotating magnetic target having an axis of rotation,
providing an control system electronic circuit board having a circuit board plane and a first circuit board side and an opposite second circuit board side, a first oriented electronic noncontacting magnetic sensor integrated on said electronic circuit board first circuit board side, a second oriented electronic noncontacting magnetic sensor integrated on said electronic circuit board second circuit board side, disposing said control system electronic circuit board proximate said control system rotating magnetic target with a projected extension of said axis of rotation extending through said first oriented electronic noncontacting magnetic sensor and said second oriented electronic noncontacting magnetic sensor wherein said first electronic noncontacting magnetic sensor and said second electronic noncontacting magnetic sensor provide a plurality of detected measured magnetic target rotary position outputs.

26. A method as claimed in claim 25, wherein said magnetic target is comprised of a permanent magnet with a north pole and a south pole opposed along a north south axis with said north south axis perpendicular with said axis of rotation.

27. A method as claimed in claim 25, wherein said electronic noncontacting magnetic sensor includes a magnetoresistive material.

28. A method as claimed in claim 25, wherein said electronic noncontacting magnetic sensor includes a Hall Effect element.

29. A method as claimed in claim 25 wherein said electronic circuit board has a less than one millimeter thickness between said first electronic noncontacting magnetic sensor and said second electronic noncontacting magnetic sensor.

30. A method as claimed in claim 25 wherein said first electronic noncontacting magnetic sensor and said second electronic noncontacting magnetic sensor provide at least a first position output, at least a second position output, and at least a third position output.

31. A method of controlling motion, said method including:
providing a magnetic field generator for generating a magnetic field with a controllable field strength,
providing a field responsive controllable material, said field responsive controllable material affected by said magnetic field generator magnetic field,
providing a magnetic target,
providing at least a first electronic noncontacting magnetic sensor, said at least first electronic noncontacting magnetic sensor integrated on an operation electronic control board having a control board plane, said operation electronic control board in electrical communication with said magnetic field generator and said control board plane oriented relative to said magnetic target, wherein said at least first electronic noncontacting magnetic sensor provides at least two detected measured positional outputs of said magnetic target with said controllable field strength generated in relationship to the at least two detected measured positional outputs.

32. A method as claimed in claim 31, said at least first electronic noncontacting magnetic sensor has a sensor plane oriented with said control board plane.

33. A method as claimed in claim 32, said method including providing a second electronic noncontacting magnetic sensor with a sensor plane, said second electronic noncontacting magnetic sensor integrated on said operation electronic control board with said second electronic noncontacting magnetic sensor plane oriented parallel with said control board plane, with said control board plane between said second electronic noncontacting magnetic sensor plane and said first electronic noncontacting magnetic sensor plane.

34. A method as claimed in claim 31, wherein said at least first electronic noncontacting magnetic sensor includes a magnetoresistive material.

35. A method as claimed in claim 31, wherein said at least first electronic noncontacting magnetic sensor includes a Hall Effect element.

36. A controllable brake comprising:
a housing comprising a first chamber and a second chamber,
a shaft, the shaft extending through the first chamber and the second chamber with an axis of rotation, said shaft having a first shaft end,
a controllable brake rotor made integral with the shaft, said rotor housed in the first chamber, said rotor having a rotation plane,
a controllable brake magnetic field generator located in the first chamber proximate the controllable brake rotor, said controllable brake magnetic field generator for generating a controllable magnetic field strength, and
a controllable brake rotating magnetic target integral with said shaft proximate said first shaft end, said controllable brake rotating magnetic target housed in the second chamber, and a controllable brake electronics first electronic noncontacting magnetic sensor having a first sensor plane, said first electronic noncontacting magnetic sensor mounted in said second chamber with said first sensor plane parallel with said controllable brake rotor rotation plane, said first electronic noncontacting magnetic sensor monitoring the rotation of said controllable brake rotating magnetic target and said controllable brake rotor and simultaneously outputting at least two rotational positions of said controllable brake rotor wherein the controllable magnetic field strength generated by said controllable brake magnetic field generator is determined by said rotational positions to control a relative motion of said controllable brake rotor.

37. A controllable brake as substantially described herein and/or substantially shown in the included drawings.

38. A method of making a controllable brake as substantially described herein and/or substantially shown in the included drawings.

39. A method of controlling motion as substantially described herein and/or substantially shown in the included drawings.

40. Any invention described or claimed herein.
